(19) United States
(12) Patent Application Publication
(10) Pub. No.: US 2015/0317815 A1
(43) Pub. Date: Nov. 5, 2015

(54) Chemistry Instruction Material

(71) Applicant: Julia English WINTER, Bloomfield Hills, MI (US)

(72) Inventor: Julia English WINTER, Bloomfield Hills, MI (US)

(21) Appl. No.: 14/700,722

(22) Filed: Apr. 30, 2015

Related U.S. Application Data
(60) Provisional application No. 61/996,211, filed on Apr. 30, 2014.

(51) Int. Cl. G06T 11/60; G06F 3/033

(52) U.S. Cl. CPC G06T 11/60; G06F 3/033

(57) ABSTRACT

A method for teaching chemical reaction mechanisms to a user includes a step of presenting a user with a graphical representation of a first molecule including a plurality of atoms. The graphical representation is presented to the user on a display. A first atom selection or bond selection is received from the user by a pointing device. A first set of atom features or bond feature are graphically displayed to the user. A first input is received from the user to alter bonding or structure of the first molecule. A graphical display of an altered molecule representing the first selection is presented on the display.

### CROSS-REFERENCE TO RELATED APPLICATION

This application claims the benefit of U.S. Provisional Application Ser. No. 61/996,211 filed Apr. 30, 2014, the disclosure of which is hereby incorporated in its entirety by reference herein.

### TECHNICAL FIELD

The present invention is related to computer processor applications for teaching chemical reaction mechanisms.

### BACKGROUND

The widespread use of computers and smart devices has significantly changed the manner in which people play, learn and study. Video games are perhaps the earliest form of electronic device-based application that has attained general acceptance. More recently, electronic books are becoming more and more common and are expected to surpass paper books in the near future. Similarly, online education has become an accepted alternative to classroom study.

For the most part, video games, though widespread, provide little educational benefit. The typical video game provides significant visual stimulation and perception of action. Educational video games do exist, but tend to be directed more to the elementary school level. Advanced electronic games such as electronic crossword puzzles are typically just direct conversions of the paper game to electronic form. Few electronic games target an older audience to teach advanced scientific and engineering topics.

Accordingly, there is a need for advanced computer games that are enjoyable for users while teaching difficult scientific and engineering concepts.

### SUMMARY

The present invention solves one or more problems of the prior art by providing, in at least one embodiment, a method for teaching chemical reaction mechanisms to a user. The method includes a step of presenting a user with a graphical representation of a first molecule including a plurality of atoms. The graphical representation is presented to the user on a display. A first atom selection or bond selection is received from the user by a pointing device. A first set of atom features or bond features are graphically displayed to the user. A first input is received from the user to alter bonding or structure of the first molecule. A graphical display of an altered molecule representing the first selection is presented on the display.

The present invention solves one or more problems of the prior art by providing, in at least one embodiment, an electronic device that executes the method set forth above. The electronic device includes a display and a computer processor. The computer processor is configured to present to a user a graphical representation of a first molecule including a plurality of atoms on the display. The computer processor is also configured to receive a first atom selection or bond selection from the user by a pointing device. The computer processor is also configured to display a first set of atom features or bond features to the user. The computer processor is also configured to receive a first input from the user to alter bonding or structure of the first molecule. The computer processor is also configured to display an altered molecule representing the first selection.

In another embodiment, a non-transitory computer-readable medium that includes instructions for a stereochemistry game application is provided. The instructions, when executed by a computer processor, perform operations that present to a user a graphical representation of a first molecule including a plurality of atoms on the display, receive a first selection from the user by a pointing device, display a first set of atom features or bond features to the user, receive a first input from the user to alter bonding or structure of the first molecule, and display an altered molecule representing the first selection.

### BRIEF DESCRIPTION OF THE DRAWINGS

FIG. 1 is a schematic illustration of an electronic device implementing a chem-instructor method;

FIG. 2A provides a schematic that illustrates user interaction with a chemical bond during implementation of the chem-instructor method;

FIG. 2B provides a schematic illustrating user interaction with an atom in the chem-instructor method;

FIG. 2C illustrates a user forming a bond by a nucleophilic reaction by the chem-instructor method;

FIG. 2D illustrates a user breaking bonds in the chem-instructor method;

FIG. 2E illustrates the use of implied carbons by the chem-instructor method;

FIG. 2F illustrates a scenario in which a molecule has labeled carbons (a,b,c) to provide the user clues that these carbons may be important parts of the reaction;

FIG. 2G illustrates the bond forming capacity of the chem-instructor method;

FIG. 2H illustrates displaying of illegal bonds by the chem-instructor method;

FIG. 21 illustrates the use of shorthand notation by the chem-instructor method;

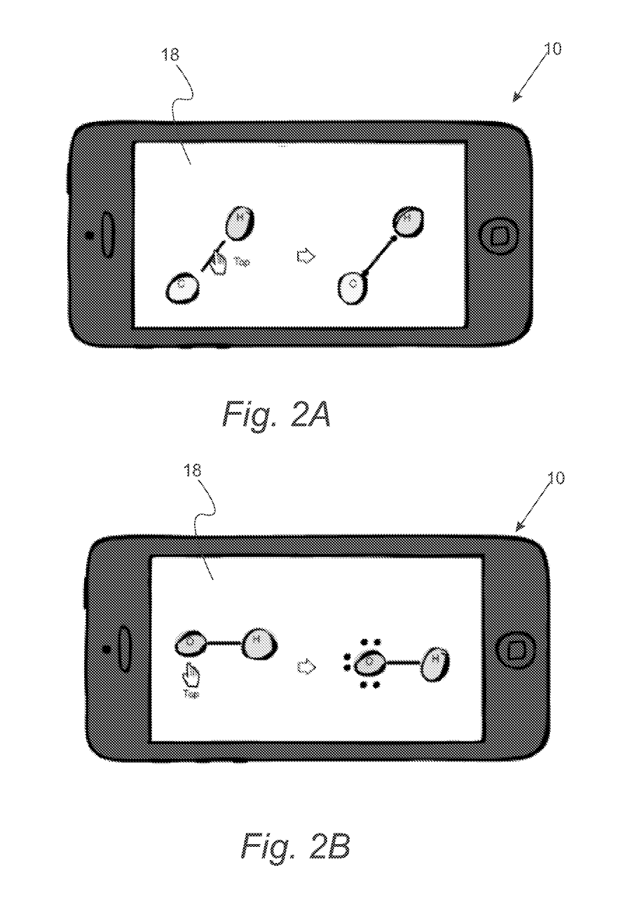

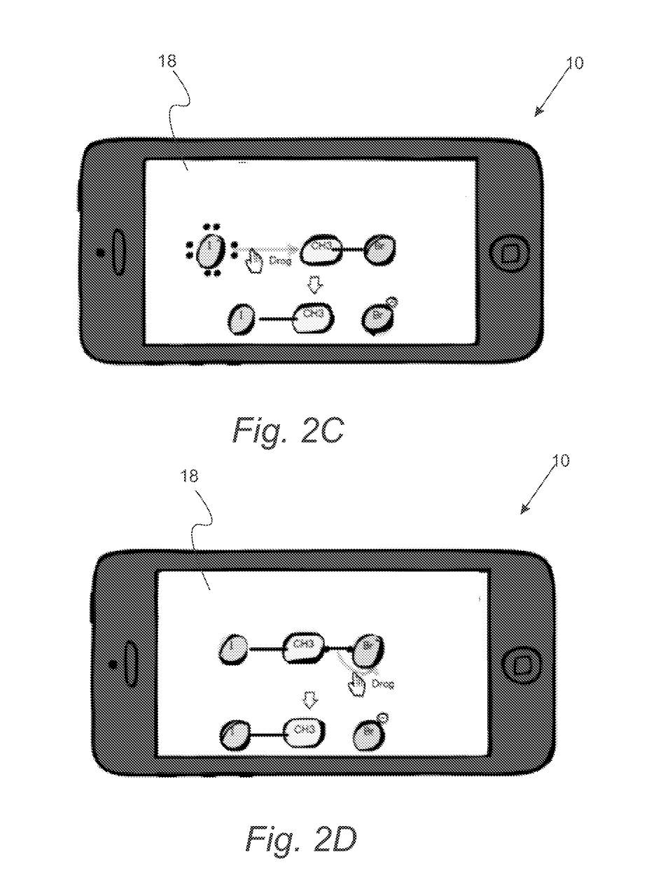

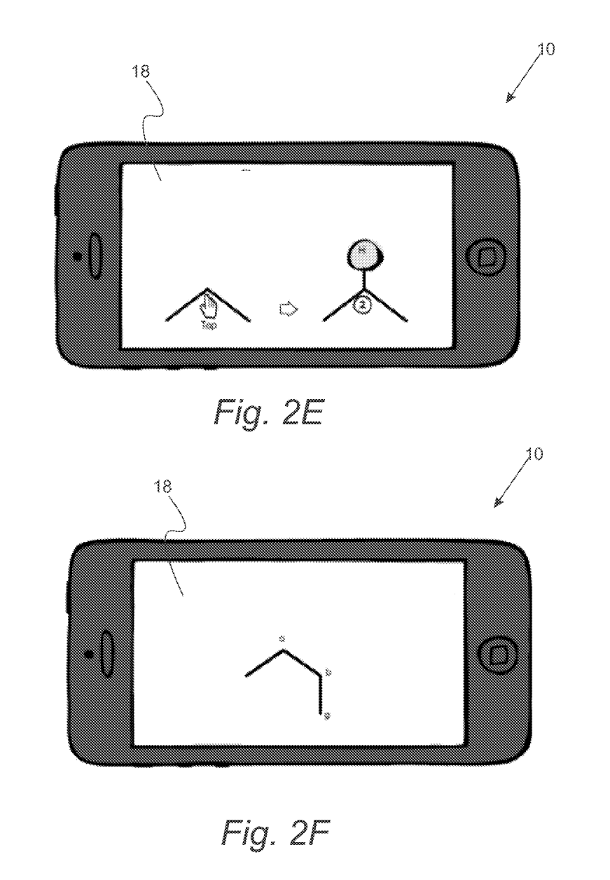

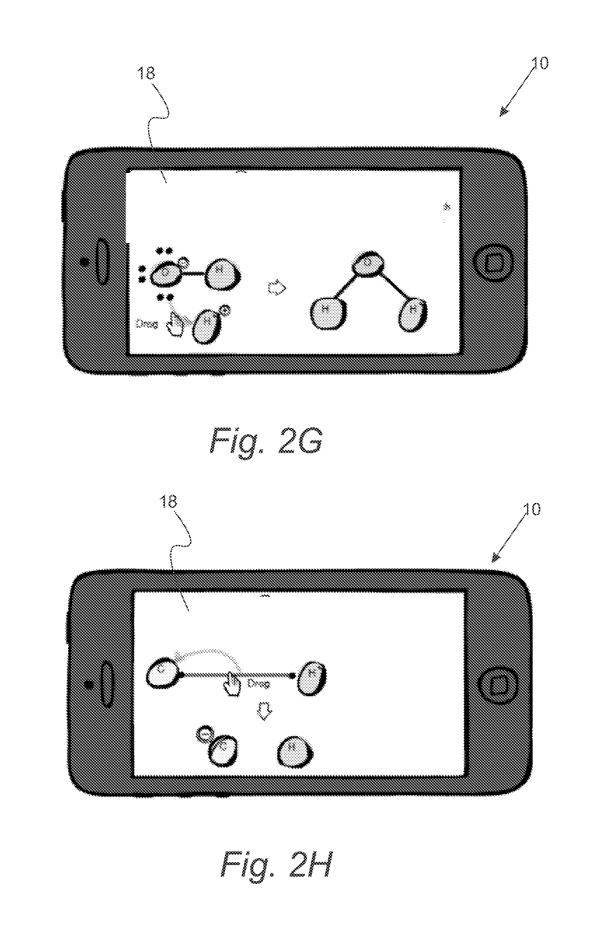

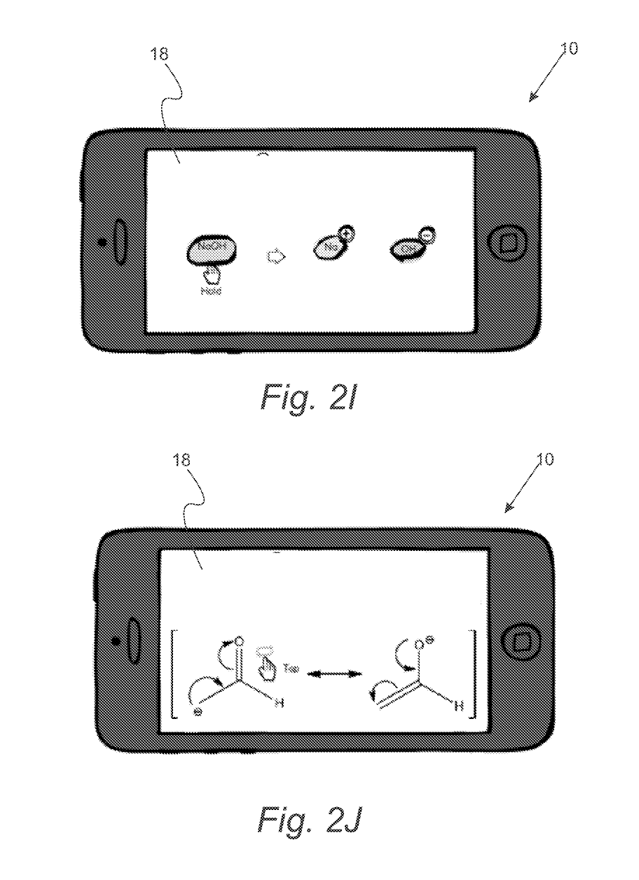

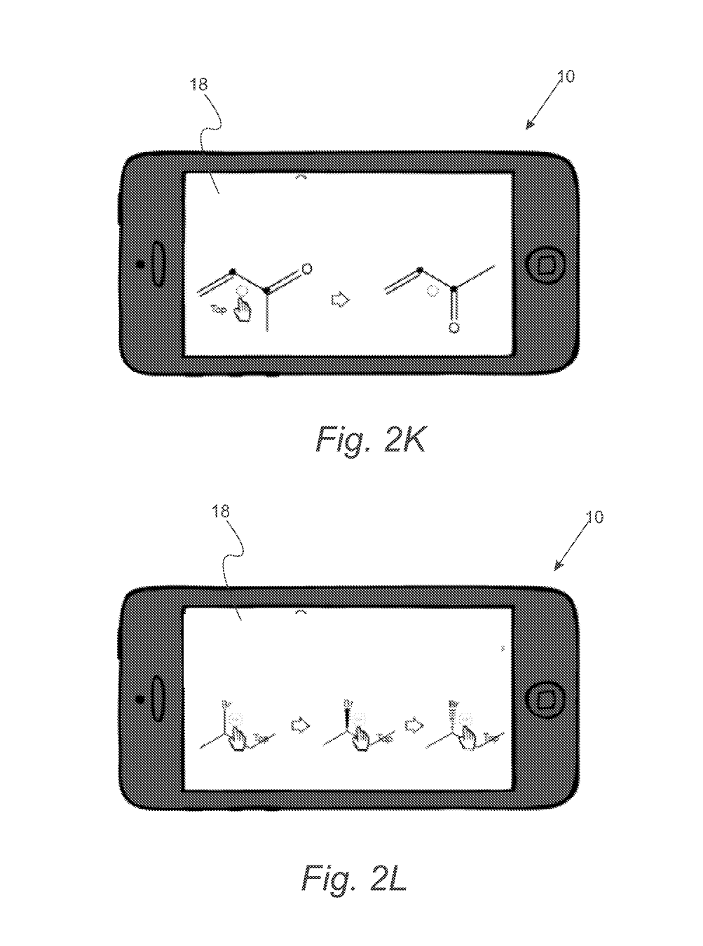

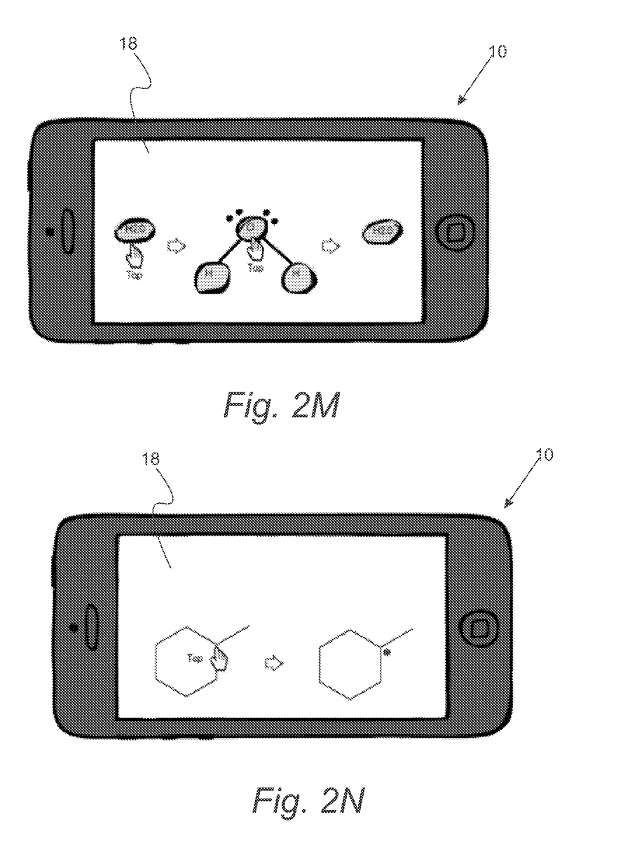

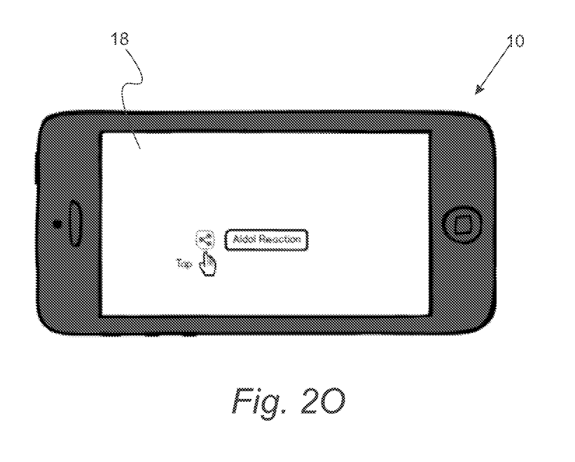

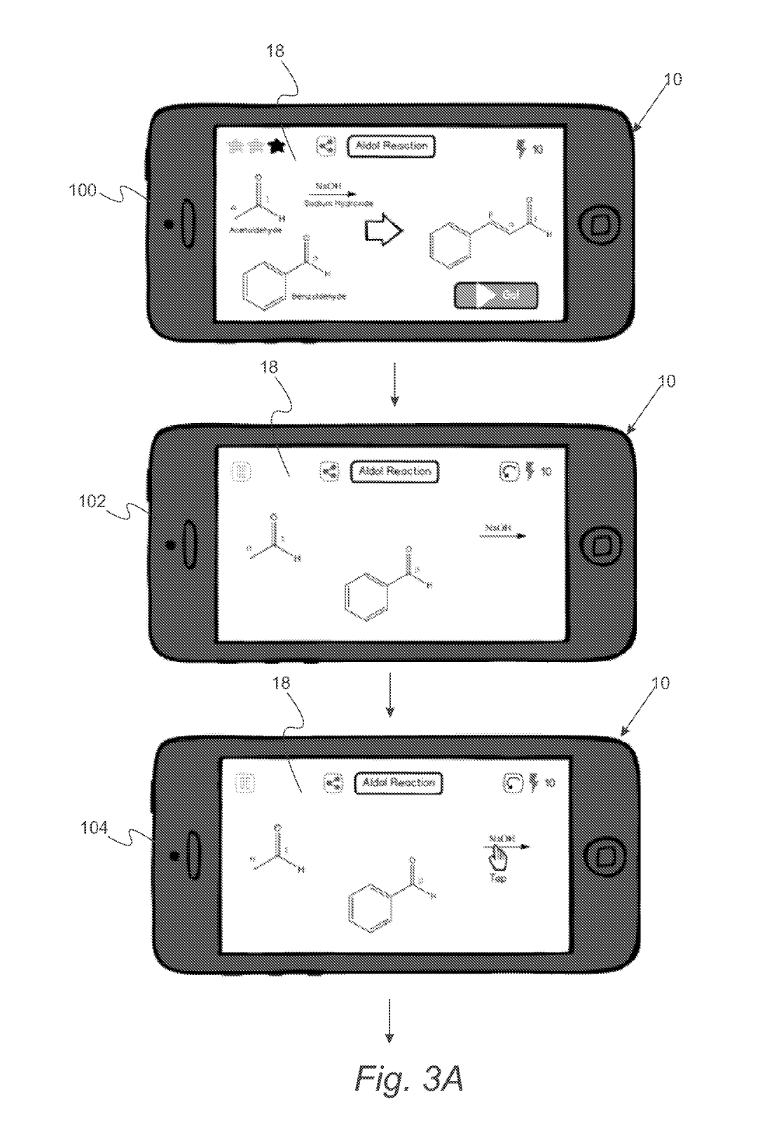

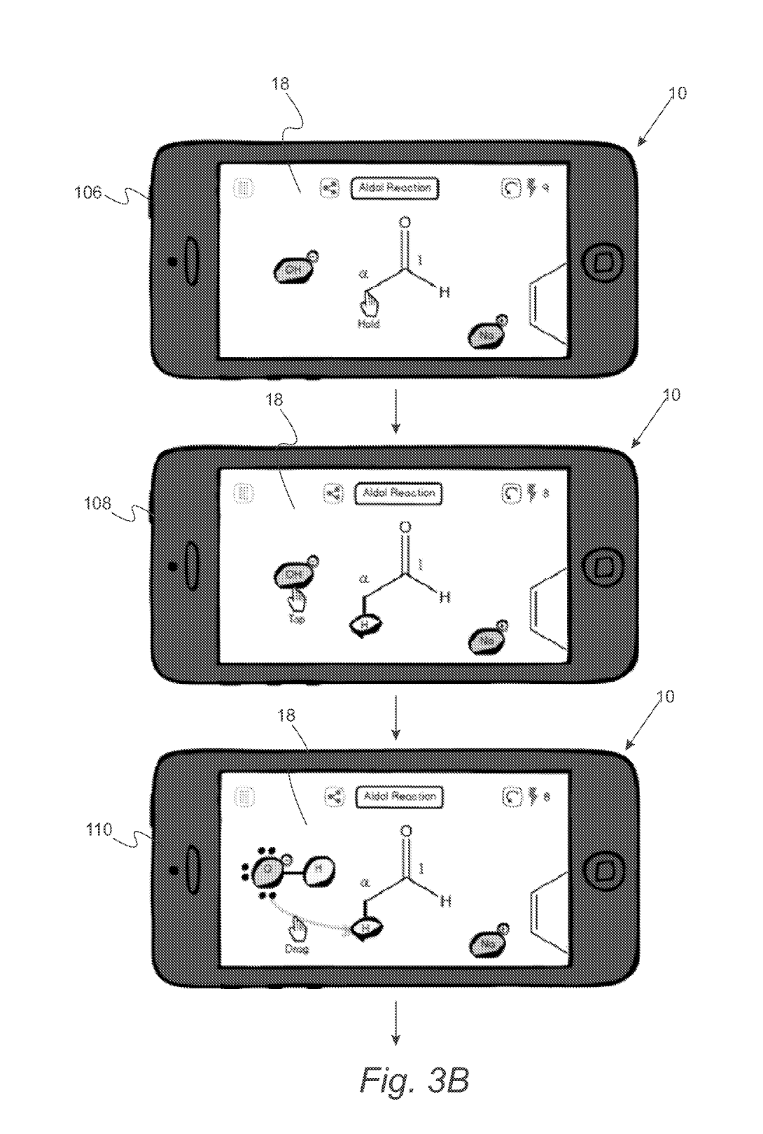

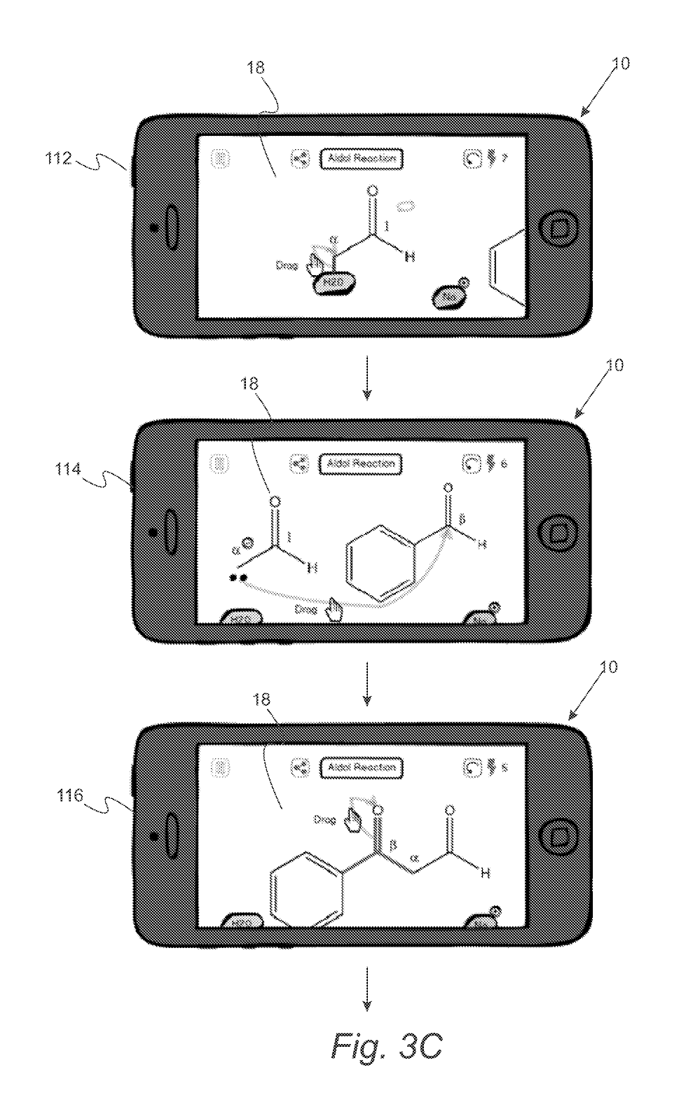

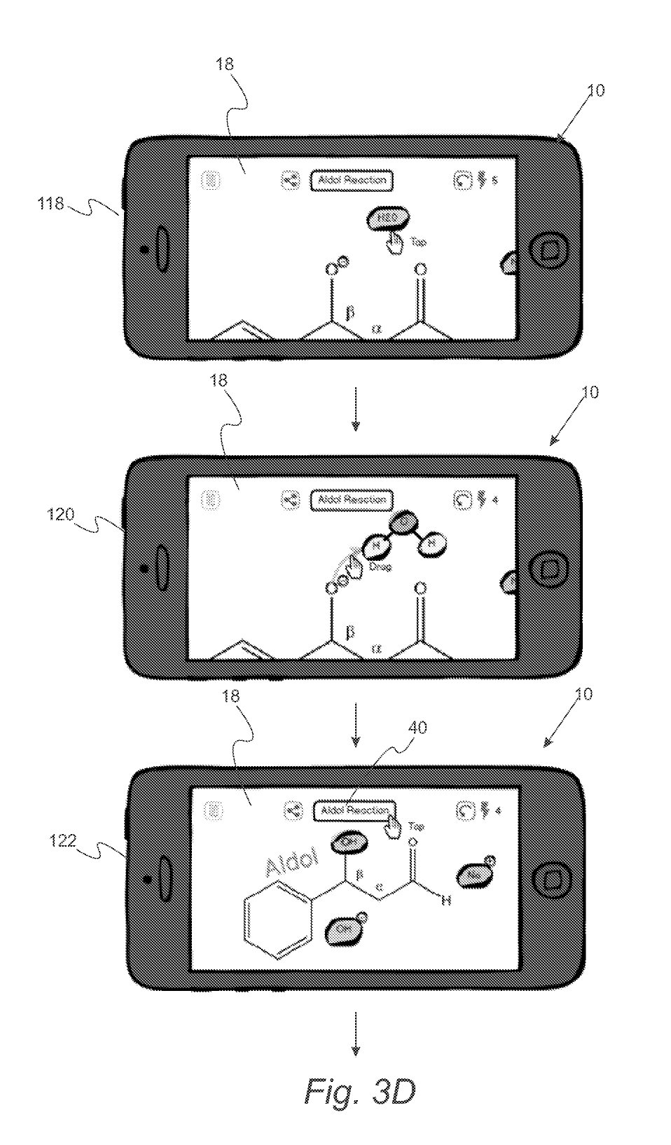

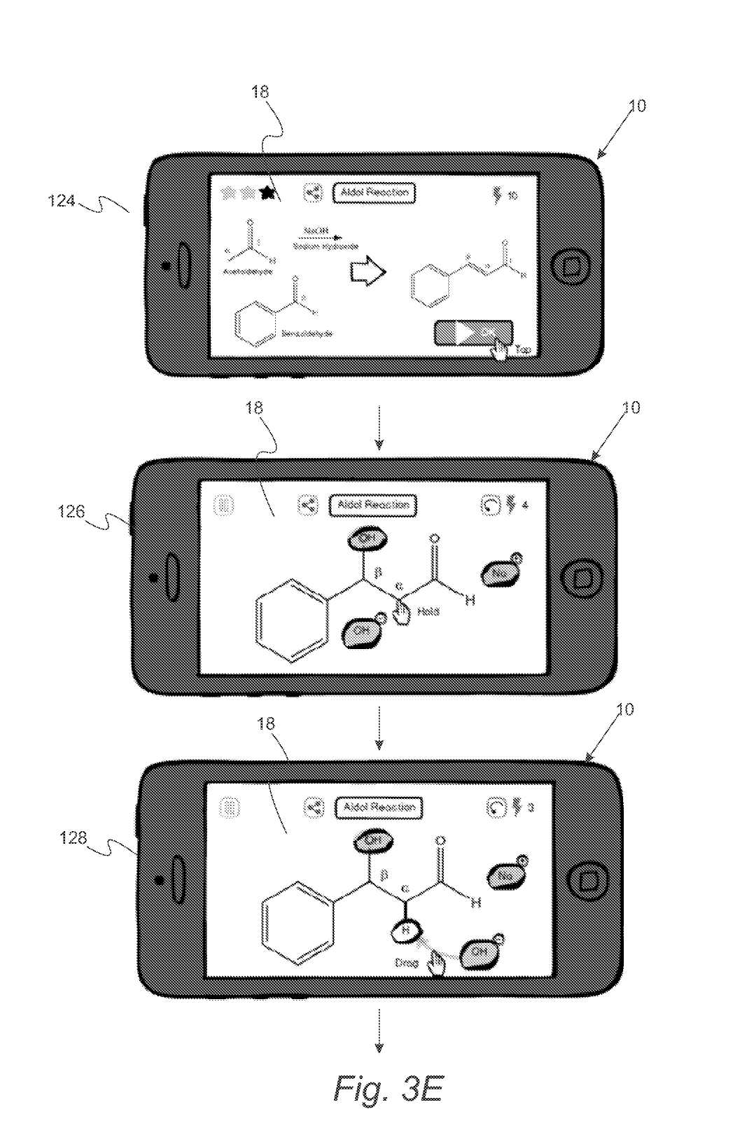

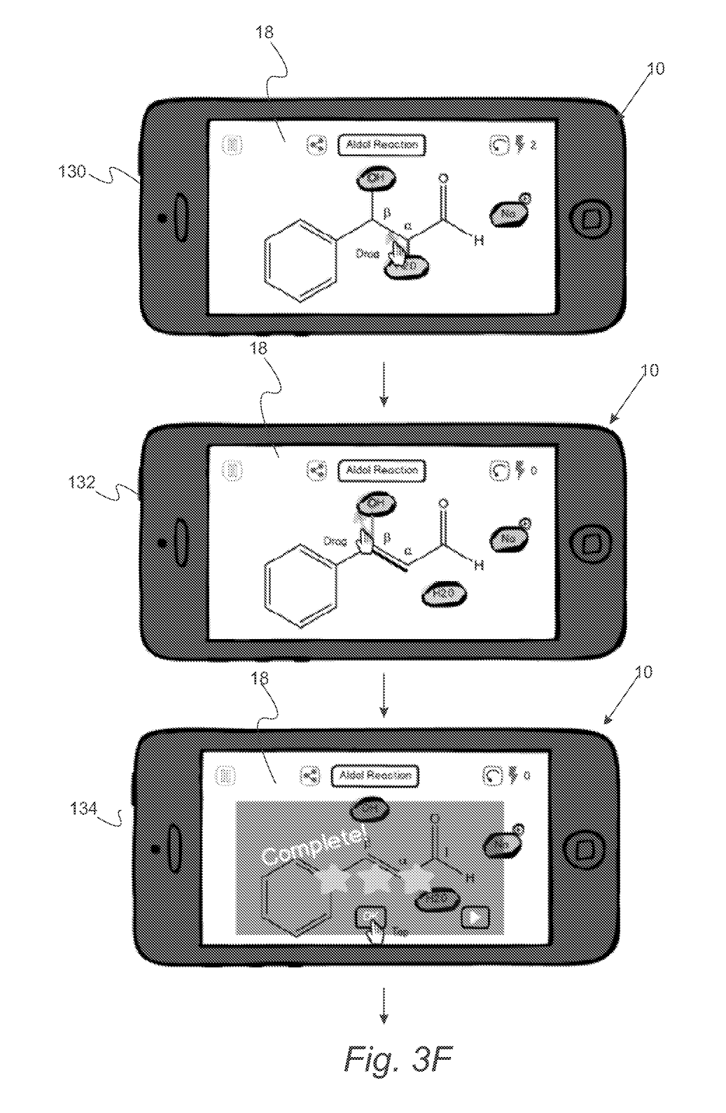

FIG. 2J depicts the presentation of resonance structures by the chem-instructor method;

FIG. 2K illustrates single C-C rotation by the chem-instructor method;

FIG. 2L illustrates the rendering of stereospecific bonds by the chem-instructor method;

FIG. 2M illustrates the conversions of shorthand to a representation of molecular structures by the chem-instructor method;

FIG. 2N illustrates the implementation of carbocations by the chem-instructor method;

FIG. 2O illustrates the implementation of stereochemical representations by the chem-instructor method;

FIG. 3A is a schematic flowchart of the chem-instructor method for an Aldol reaction;

FIG. 3B is a continuation of the flowchart of FIG. 3A;

FIG. 3C is a continuation of the flowchart of FIG. 3B;

FIG. 3D is a continuation of the flowchart of FIG. 3C;

FIG. 3E is a continuation of the flowchart of FIG. 3D; and

FIG. 3F is a continuation of the flowchart of FIG. 3E.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein some features may be exaggerated or minimized to show details of particular components. Therefore, specific structural and functional details disclosed herein are not to be interpreted as limiting, but merely as a representative basis for teaching one skilled in the art to variously employ the present invention.

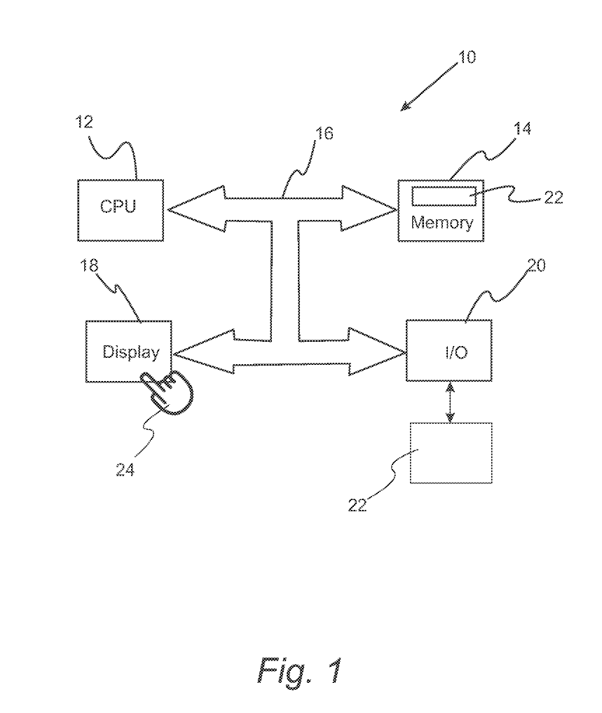

With reference to FIG. 1, a schematic illustration of an electronic device for teaching chemical reaction mechanisms is provided. Chem-instructor device 10 includes computer processor 12 that executes the instructions for teaching chemical reaction mechanism (i.e., the chem-instructor method). It should be appreciated that virtually any type of computer processor may be used, including microprocessors, multicore processors, and the like. The instructions for the game typically are stored in computer memory 14 and accessed by computer processor 12 via connection system 16. In a variation, connection system 16 includes a data bus. In a refinement, computer memory 14 includes a computer-readable medium which can be any non-transitory (e. g., tangible) medium that participates in providing data that may be read by a computer. Specific examples for computer memory 14 include, but are not limited to, random access memory (RAM), read only memory (ROM), hard drives, optical drives, removable media (e.g. compact disks (CDs), DVD, flash drives, memory cards, etc.), and the like, and combinations thereof In another refinement, computer processor 12 receives instructions from computer memory 14 and executes these instructions, thereby performing one or more processes, including one or more of the processes described herein. Computer-executable instructions may be compiled or interpreted from computer programs created using a variety of programming languages and/or technologies including, without limitation, and either alone or in combination, Java, C, C++, C#, Fortran, Pascal, Visual Basic, Java Script, Perl, PL/SQL, etc. Display 18 is also in communication with computer processor 12 via connection system 16. Chem-instructor device 10 also includes various in/out ports 20 through which data from a pointing device 22 may be accessed by computer processor 12. Examples for the electronic device include, but are not limited to, desktop computers, smart phones, tablets, or tablet computers. Specifically, the chem-instructor method can be implemented by IPads, IPods, and other tablets. Examples of pointing devices include a mouse, touch screen, stylus, trackball, joystick or touch pad. In a particularly useful variation, the pointing device is incorporated into display 18 as a touch screen by which user 24 interacts with a finger.

In general, a computer processor 12 performs (i.e., executes) operations that present a user with a graphical representation of a first molecule including a plurality of atoms that is presented on display 18; receive a first atom or bond selection from the user by a pointing device 22; present a first set of atom features to the user for the first atom or bond selection; receive a first input from the user to alter bonding or structure of the first molecule; and display an altered molecule from the first input. In a variation, the first set of atom or bond features includes a depiction of electrons that can be manipulated by the user. Typically, the depiction of electrons is manipulated by the user dragging the depiction of electrons to atoms or other bonds. In a refinement, the first set of atom features includes a graphical representation of valence electrons for the first atom selection. In a further refinement, the user provides input by the pointing device 22 for moving the valence electrons. In certain variations, a user breaks a bond by first selecting a bond and then dragging from the center of the bond to the atom which will receive the electrons. Clues can be optionally provided to indicate atoms that are to be involved in the mechanism. The user can actuates an atom (e.g. carbon) to reveal the implied hydrogen atoms. In some variations, resonance structures are displayed by presenting an icon to the user that allows cycling between structures via user actuation of the icon. In a typical application, a graphical representation of one or more additional molecule is presented to the user on display 18. The user can symbolically move (i.e., drag) electrons from the first molecule to the additional molecules to form a bond when a bond may be properly formed.

With reference to FIGS. 1 and 2A-O operational features of the chem-instructor device and method are provided. FIGS. 2A-O provide schematic examples of these features. FIG. 2A provides a schematic that illustrates user interaction with a chemical bond during implementation of the chem-instructor method. Bonds are formed between atoms. A user taps on the bond displayed in display 18 of electronic device 10 to show the electrons that can be manipulated to give fine control over a bond. Throughout these figures, the input from the user is pictorially indicated by an icon of a hand. FIG. 2B provides a schematic illustrating user interaction with an atom. Atoms are the basic unit of matter. A user taps on an atom to show the atom's lone pairs which can be used to form bonds. FIG. 2C illustrates a user forming a bond by a nucleophilic reaction. Nucleophilic reactions occur when a pair of electrons is used to make a bond. Bonds are formed by dragging electrons to atoms or other bonds. FIG. 2D illustrates a user breaking bonds in the chemical reaction program. A user breaks a bond by first selecting a bond by tapping on it. The user then drags from the center of the bond to the atom which will receive the electrons. FIG. 2E illustrates the implementation of implied carbons. Carbons are implied at every unnamed intersection. Tapping on the intersection will provide a connected hydrogen and show the number of hydrogen atoms remaining FIG. 2F illustrates a scenario in which a molecule has labeled carbons (a,b,c) to provide the user clues that these carbons may be important parts of the reaction. FIG. 2G illustrates the bond forming capacity of the chem-instructor method. For example, acid/base reactions occur when a pair of electrons on a base is used to make a bond to H⁺. They are represented by arrows which are formed by the path of the pointing device within display 18. Acid/Base reactions always have arrows moving them from the base to the acid. FIG. 2H illustrates a scenario in which the user is provided feedback that an illegal bond has been created. In the example of this figure, illegal bonds have a red glow around them. In a refinement, the module requires that these bonds be broken.

FIG. 2I depicts the use of shorthand notation by the chem-instructor method. Some molecules are written in shorthand to clear up the models. Tapping and holding on the shorthand representation will perform the special action for the molecule. Not all ions are used. FIG. 2J depicts the presentation of resonance structures by the chem-instructor method. Resonance structures have the same arrangement of atoms but different arrangements of electrons. If resonance structures are available, an icon will appear next to the molecule to allow cycling between structures via user actuation of the icon. FIG. 2K illustrates the chem-instructor bond rotation feature. Carbon-Carbon single bonds can be rotated. When the bond is selected, a rotation will appear. Tapping on the rotation icon will rotate the bond. FIG. 2L depicts stereospecific bonds. In stereo mode, bonds can be converted to wedges that go into or out of the plane. When the bond is selected, an icon will let you cycle between these states. FIG. 2M depicts shorthand notation. Tapping on shorthand notation which will expand the molecule to give you more control over the reaction. Tapping again will return the molecule back to shorthand notation. FIG. 2N depicts carbocation. Carbons with only three bonds have a plus charge and are called a carbocation. The plus charge can be dragged to another valid location. FIG. 2O illustrates the capacity of the chem-instructor method to display stereochemical relationships. Certain reactions are stereospecific, meaning they produce one stereoisomer over another. To see the stereochemistry representation of the reaction, a user actuates a stereochemistry button next to the title to toggle between flat and stereochemistry.

FIGS. 3 provides a schematitc flowchart of the chem-instructor method for an Aldol reaction. In step 100, a user is presented with the goal. Throughout these figures, the input from the user is pictorially indicated by an icon of a hand. In a refinement, the user's goal is to solve the presented problem within a predetermined number of steps (e.g., to get three stars). The displayed play button will glow to indicate the next step. In step 102, the user manipulates the position of molecules in the display area by pointing device 22. Tapping on pause will bring up the pause menu where the user can adjust the game settings or return to the main screen. The step indicator will show the player how many steps remain to get a perfect score in the reaction. The title can be clicked on, to re-display the goal. The undo button will allow users to reverse steps in order. The play area can be panned and zoomed using standard multi-touch interactions. In step 104, an atom splitting feature of the chem-instructor method is implemented. In this specific example, the user taps on the NaOH shorthand to create Na^{|} and OH⁻. In step 106, the user pans and zooms the view to get a better view of the acetaldehyde and the OH. The user holds on the alpha carbon to perform its special action, exposing an H.

In step 108, the user taps on the OH⁻ graphic to expose the electrons needed to form a bond with the H. In step 110, the user performs a simulation of a nucleophilic reaction on H using electrons from the O. A trail is drawn between a line pair and the H. In step 112, the consequence of forming an invalid chemical bond with the chem-instructor method is illustrated. In this example, although joining OH⁻ and H created water, an invalid bond between the water molecule and the alpha carbon still exists. The user breaks the bond, putting the electron back on to the alpha carbon thereby creating a negatively charged alpha carbon. In a refinement, the user can cycle through resonance structures.

In step 114, the user pans and zooms the view by actuating the pointing device about the display to get a good look at the acetaldehyde and benzaldehyde. The user performs a nucleophilic attack between the negative alpha carbon and the beta carbon. In step 116, a step of breaking chains is depicted. In this example, combining the acetaldehyde and benzaldehyde has created an illegal bond on the beta carbon. One of those must be broken. The user decides to break the double O bond on the benzaldehyde creating a negatively charted O ion that will be used later.

In step 118, the expansion feature is utilized to expand a shortcut of a water molecule to a molecular representation of water. In breaking water step 120, the user combines the H₂O and the negatively charged O to create OH and OH−. In step 122, the user creates a known molecule with the name being briefly displayed. In a refinement, positive feedback is provided on display 18 to reinforce the user's learning. In another refinement, the user can tap on title 40 to reference the goal.

In step 124, the user reviews the goal. In this specific example, the user observes that they are almost there except for a PI bond between the alpha and beta carbons as well as the extra OH on the beta carbon. The user can then click on the title or the OK button to go back to the play space. In step 126, the user decides to create the PI bond between alpha and beta carbons first. Knowing they can create water with OH−, they tap hold alpha to expose on H.

In step 128, the user combines H and OH− to create another water molecule which forms an illegal bond between alpha and the water. This is exactly what the user expected and needed to get an electron for the PI bond. In step 130, the user moves one of the H and OH− to create a water molecule. This specific example depicts an illegal bond being formed between an alpha carbon and the water. This is exactly what the user expected and needed to get an electron for the PI bond. The user breaks the bond by dragging the electron to the bond between alpha and beta, creating the PI bond. In step 132, the only remaining task is to break off the OH thereby creating Off. The user drags the bond between OH and the beta carbon and puts the electrons on OH thereby creating Off. In step 134, the user has completed the reaction in the required amount of steps and is presented with some congratulatory text and 3 stars. Tapping the OK button returns the user to the scenario selection screen. If the user taps the play button, they are shown a real-time replay of their moves and the reaction animations.

In a refinement of the embodiments and variations set forth above, the chem-instructor method provides the user with a score to provide feedback regarding the users performance. Such a score can be based on the time to complete a task, the number of steps to complete a task or a combination thereof. In another refinement, the chem-instructor method is repeated with the user achieving a cumulative score indicating the user's success.

In another embodiment, a non-transitory computer-readable medium that includes instructions for one or more of the chem-instructor method is provided. Details regarding the chem-instructor method are set forth above. Specific examples of such non-transitory memory include. but are not limited to, read only memory (ROM), hard drives, optical drives, removable media (e.g. compact disks, DVD, flash drives, memory cards, etc.), and the like, and combinations thereof. The instructions, when executed by a computer processor, perform operations that present a user with a graphical representation of a first molecule including a plurality of atoms, the graphical representation being presented on a display; receive a first atom or bond selection from the user by a pointing device; present a first set of atom features to the user for the first atom or bond selection; receive a first input from the user to alter bonding or structure of the first molecule; and display an altered molecule from the first input. Additional details regarding the operations performed by the instructions are set forth above with respect to the electronic devices described by FIG. 1. Moreover, non-transitory computer-readable medium is used in a desktop computer, a smart phone, a tablet, or a tablet computer.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method comprising:
a) presenting a user with a graphical representation of a first molecule including a plurality of atoms, the graphical representation being presented on a display;
b) receiving a first atom or bond selection from the user by a pointing device;
c) presenting a first set of atom features to the user for the first atom or bond selection;
d) receiving a first input from the user to alter bonding or structure of the first molecule; and
e) displaying an altered molecule from the first input.

2. The method of claim 1 wherein the pointing device is a mouse, touch screen, stylus, trackball, joystick or touch pad.

3. The method of claim 1 wherein the first set of atom features includes a graphical representation of valence electrons for the first atom selection.

4. The method of claim 3 wherein the user provides input by the pointing device for moving the valence electrons.

5. The method of claim 4 wherein the first set of atom or bond features includes a depiction of electrons that can be manipulated by the user.

6. The method of claim 5 wherein the depiction of electrons is manipulated by the user dragging the depiction of electrons to atoms or other bonds.

7. The method of claim 5 wherein a user breaks a bond by first selecting a bond and then dragging from the center of the bond to the atom which will receive the electrons.

8. The method of claim 1 wherein clues are provided to indicate atoms that are to be involved in the mechanism.

9. The method of claim 1 wherein the user actuates an atom to reveal the implied hydrogen atoms.

10. The method of claim 1 wherein resonance structures are displayed by presenting an icon to the user that allows cycling between structures via user actuation of the icon.

11. The method of claim 1 further comprising:
f) presenting the user with a graphical representation of a second molecule including a plurality of atoms, the graphical representation of the second molecule being presented on a display;
g) receiving input from the user to move electrons from the first molecule to the second molecule to form a bond.

12. An electronic device for playing a game:
a display;
a computer processor configured to:
present a user with a graphical representation of a first molecule including a plurality of atoms, the graphical representation being presented on a display;
receive a first atom or bond selection from the user by a pointing device;
present a first set of atom features to the user for the first atom or bond selection; and
receive a first input from the user to alter bonding or structure of the first molecule; and
display an altered molecule from the first input.

13. The electronic device of claim 12 wherein the display is a touch screen display by which the user creates the first input using touch screen operations to receive the first atom or bond selection.

14. The electronic device of claim 12 further comprising a pointing device with which the user creates the first input.

15. A non-transitory computer-readable medium comprising instructions of a game application that, when executed by a computer processor, perform operations of:
present a user with a graphical representation of a first molecule including a plurality
of atoms, the graphical representation being presented on a display;
receive a first atom or bond selection from the user by a pointing device;
present a first set of atom features to the user for the first atom or bond selection;
receive a first input from the user to alter bonding or structure of the first molecule; and
display an altered molecule from the first input.
